(19) United States
(12) Patent Application Publication
(10) Pub. No.: US 2026/0243630 A1
(43) Pub. Date: Aug. 20, 2026

(54) PROGRAMMING DEVICE

(71) Applicant: FANUC CORPORATION, Minamitsuru-gun, Yamanashi (JP)

(72) Inventor: Hiroyuki YONEYAMA, Yamanashi (JP)

(21) Appl. No.: 18/992,709

(22) PCT Filed: Aug. 1, 2022
(86) PCT No.: PCT/JP2022/029530

§ 371 Date: Jan. 9, 2025

(51) Int. Cl. G01M 99/00

(52) U.S. Cl. CPC G01M 99/00

(57) ABSTRACT

Provided is a programing device for creating a measurement program that disposes an industrial machine system model including an industrial equipment model and a measurement object model in a virtual space, and measures a plurality of measurement sites on the measurement object model. The programing device comprises: a measurement site setting unit that sets a plurality of measurement sites on the measurement object model; a distance calculation unit that calculates the distance between respective adjacent measurement sites in a region formed by connecting the plurality of measurement sites; an area calculation unit that calculates the area of the region; a measurement site evaluation unit that evaluates whether or not measurement with a preset and predetermined accuracy or higher is possible at the plurality of measurement sites; and a teaching point generation unit that generates the plurality of measurement sites as teaching points to be measured by an industrial machine.

### TECHNICAL FIELD

The present invention relates to a programming device.

### BACKGROUND ART

A technique is known in which: a workpiece model, a robot model, and an imaging unit model are disposed in a virtual space; target sites on the workpiece model that correspond to to-be-imaged sites on a workpiece are extracted in accordance with preset extraction conditions; the imaging unit model or the workpiece model is moved by the robot model to an imaging position at which the target sites are in the field of view of the imaging unit model; and an operation program for causing the imaging unit to image the to-be-imaged sites is generated on the basis of position data pertaining to the robot model that is obtained when the robot model positions the imaging unit model or the workpiece model at the imaging position, thereby enabling the reduction of tasks that the operator is required to perform to generate the operation program for the robot. Reference should be made to, for example, Patent Document 1.

### CITATION LIST

### Patent Document

Patent Document 1: Japanese Unexamined Patent Application, Publication No. 2019-18250.

### DISCLOSURE OF THE INVENTION

### Problems to be Solved by the Invention

When measuring a plurality of measurement sites on a to-be-measured object such as a workpiece by using a measurement program, teaching points (measurement sites) need to be set for the measurement program such that: the distance between the measurement sites is not shorter than a prescribed distance; and a range on the to-be-measured object that is wider than a prescribed area is measured.

Thus, when the measurement is accurately performed in the virtual space and in the real space with the space between adjacent teaching points (measurement sites) for the measurement program having been appropriately set such that the distance between the measurement sites is not shorter than the prescribed distance and a range on the to-be-measured object that is wider than the prescribed area is measured, the accuracy of calculation of an error in position between a to-be-measured object model in the virtual space and the to-be-measured object in the real space is enhanced so that misalignment after correction can be suppressed between the position of the to-be-measured object model in the virtual space and the position of the to-be-measured object in the real space.

Conversely, if the space between adjacent teaching points for the measurement program is not appropriately set, e.g., if the distance between the measurement sites is shorter than the prescribed distance, if a narrow range on the to-be-measured object that is equal to or smaller than the prescribed area is measured, or if measurement sites are arranged in a straight line on the to-be-measured object, then, even when the measurement is accurately performed in the virtual space and in the real space, the accuracy of calculation of an error between positions on the to-be-measured object model in the virtual space and positions on the to-be-measured object in the real space is reduced, and thus misalignment after correction may become larger between the position of the to-be-measured object model in the virtual space and the position of the to-be-measured object in the real space.

Meanwhile, the setting of measurement sites on the to-be-measured object is largely dependent on the operator's experience, and it would be difficult for an inexperienced operator to set measurement sites such that the distance between the measurement sites is not shorter than the prescribed distance and a range on the to-be-measured object that is wider than the prescribed area is measured, thereby leading to the problem of taking time for trial and error to set appropriate measurement sites.

If measurement sites are not appropriately set and misalignment after correction becomes larger between the position of the to-be-measured object model in the virtual space and the position of the to-be-measured object in the real space, the process needs to be performed again starting from the creation of the measurement program in the virtual space, thereby leading to the problem of large time loss.

Accordingly, it is desirable to allow teaching points to be easily set for a measurement program for measuring a plurality of measurement sites on a to-be-measured object.

### Means for Solving the Problems

One aspect of the programming device of the present disclosure provides a programming device for creating a measurement program, the measurement program being for disposing, in a virtual space, an industrial machine system model that three-dimensionally represents an industrial machine system including an industrial machine and a to-be-measured object and includes an industrial equipment model and a to-be-measured object model, and for measuring a plurality of measurement sites on the to-be-measured object model, the programming device including: a measurement-site setting unit configured to set the plurality of measurement sites on the to-be-measured object model; a distance calculation unit configured to calculate the distances between adjacent measurement sites in a region formed by linking the plurality of measurement sites; an area calculation unit configured to calculate the area of the region; a measurement-site evaluation unit configured to evaluate, on the basis of the area and the distances between the adjacent measurement sites, Whether measurement with a prescribed accuracy set in advance or greater can be performed at the plurality of measurement sites; and a teaching-point generation unit configured to generate, when the measurement-site evaluation unit has evaluated that measurement with the prescribed accuracy of greater can be performed, the plurality of measurement sites as teaching points to be measured by the industrial machine.

### Effects of the Invention

According to one aspect, teaching points can be easily set for the measurement program for measuring a plurality of measurement sites on a to-be-measured object.

### BRIEF DESCRIPTION OF THE DRAWINGS

FIG. 1 is a functional block diagram illustrating a functional configuration example of a programming device according to a first embodiment;

FIG. 2 illustrates an example of an industrial machine system model in a virtual space;

FIG. 3 illustrates an example of a situation in which a plurality of measurement sites have been set;

FIG. 4 illustrates an example of a situation in which a plurality of measurement sites have been set;

FIG. 5 illustrates an example of a situation in which a plurality of measurement sites have been set;

FIG. 6 illustrates an example of a situation in which a plurality of measurement sites have been set;

FIG. 7 illustrates an example of the operation of measuring measurement sites that is performed by a robot model;

FIG. 8 illustrates an example of the operation of measuring measurement sites that is performed by the robot model;

FIG. 9 illustrates an example of the operation of measuring measurement sites that is performed by the robot model;

FIG. 10 illustrates an example of the relationship between the positions of measurement sites measured on a workpiece model in a virtual space and the positions of the measurement sites measured on a workpiece in the real space;

FIG. 11 illustrates an example of the disposition position of the workpiece model in the virtual space after correction;

FIG. 12 is a flowchart illustrating correction processing performed by the programming device;

FIG. 13 is a functional block diagram illustrating a functional configuration example of a programming device according to a second embodiment;

FIG. 14 illustrates an example of shape-related features on a workpiece model;

FIG. 15 is a flowchart illustrating correction processing performed by the programming device; and

FIG. 16 illustrates an example of a situation in which a Visual sensor model has been attached to the tool leading end of the robot model.

### PREFERRED MODE FOR CARRYING OUT THE INVENTION

### First Embodiment

First, an overview of the present embodiment is described. In the present embodiment, a programming device for creating a measurement program, the measurement program being for disposing, in a virtual space, an industrial machine system model that three-dimensionally represents an industrial machine system including an industrial machine and a to-be-measured object and includes an industrial equipment model and a to-be-measured object model, and for measuring a plurality of measurement sites on the to-be-measured object model, involves: setting, on the to-be-measured object model, a plurality of measurement sites selected by a user; calculating the distances between adjacent measurement sites in a region formed by linking the plurality of measurement sites that have been set; calculating the area of the region; evaluating, on the basis of the area and the distances between the adjacent measurement sites, whether measurement with a prescribed accuracy set in advance or greater can be performed at the plurality of measurement sites; and generating, when it has been evaluated that measurement with the prescribed accuracy or greater can be performed, the plurality of measurement sites as teaching points to be measured by the industrial machine.

According to the present embodiment, as a result, teaching points can be easily set for the measurement program for measuring a plurality of measurement sites on a to-be-measured object.

The above are an overview of the present embodiment.

The following describes features of the present embodiment in detail by referring to the drawings. In the example presented in the following, a pin for touch-up is attached to the tool leading end of a robot serving as an industrial machine, so as to measure a workpiece, i.e., a to-be-measured object. It should be noted that the present invention can also be applied to, for example, situations in which a visual sensor for detection is attached to the tool leading end of the robot so as to measure the workpiece. The present invention can also be applied to various machines such as machine tools, industrial robots, service robots, forge pressing machines, injection molding machines that serve as industrial machines.

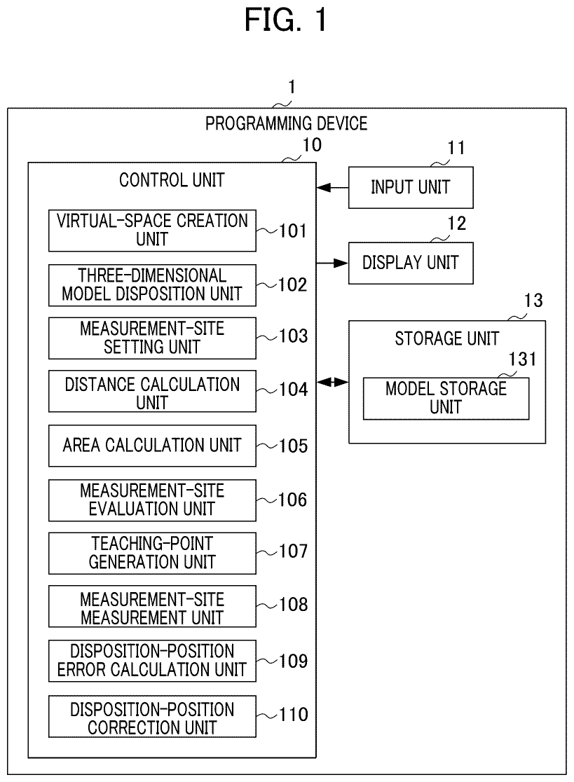

FIG. 1 is a functional block diagram illustrating a functional configuration example of the programming device according to the first embodiment.

As depicted in FIG. 1, the programming device 1 is a publicly known computer and includes a control unit 10, an input unit 11, a display unit 12, and a storage unit 13. The control unit 10 includes a virtual-space creation unit 101, a three-dimensional model disposition unit 102, a measurement-site setting unit 103, a distance calculation unit 104, an area calculation unit 105, a measurement-site evaluation unit 106, a teaching-point generation unit 107, a measurement-site measurement unit 108, a disposition-position error calculation unit 109, and a disposition-position correction unit 110.

The programming device 1 may be connected via a network such as a local area network (LAN) or the Internet to a robot control device (not shown) for controlling the operation of a robot (not shown). Alternatively, the programming device 1 may be directly connected to the robot control device (not shown) via an unshown connection interface.

### Input Unit 11

The input unit 11 is, for example, a keyboard or a touch panel disposed at the display unit 12 (described hereinafter) and accepts input from a user.

### Display Unit 12

The display unit 12 is, for example, a liquid crystal display. As will be described hereinafter, the display unit 12 displays, for example, 3D CAD data or the like that is input (selected) by the user via the input unit 11 and three-dimensionally represents a robot (not shown) (hereinafter may be referred to as a “robot model”), as well as 3D CAD data or the like that three-dimensionally represents a pin (not shown) disposed at the tool leading end of the robot so as to measure a to-be-measured object (hereinafter may be referred to as a “pin model”), 3D CAD data or the like that three-dimensionally represents a workpiece constituted by the to-be-measured object measured by the pin (not shown) (hereinafter may be referred to as a “workpiece model”), and 3D CAD data or the like that three-dimensionally represents, for example, a jig (hereinafter may be referred to as a “peripheral equipment model”).

### Storage Unit 13

The storage unit 13 is a solid state drive (SSD), a hard disk drive (HDD), or the like and may store, for example, a measurement program for operating the unshown robot so as to cause the pin to measure the workpiece. The storage unit 13 also includes a model storage unit 131.

The model storage unit 131 stores, for example: 3D CAD data that is input (selected), for example, by the user via the input unit 11 as described above and that pertains to the robot (not shown) displayed on the display unit 12 (robot model) ; 3D CAD data that pertains to the pin (not shown) (pin model) ; 3D CAD data that pertains to the workpiece (not shown) (workpiece model) ; and 3D CAD data that pertains to, for example, a jig (not shown) (peripheral equipment model).

### Control Unit 10

The control unit 10 includes, for example, a central processing unit (CPU), a read only memory (ROM), a random access memory (RAM), and a complementary metal-oxide-semiconductor (CMOS) memory, which are publicly known to those skilled in the art and configured to be capable of communicating with each other via a bus.

The CPU is a processor that controls the entirety of the programming device 1. The CPU reads, via the bus, a system program and an application program stored in the ROM, and controls the entirety of the programming device 1 in accordance with the system program and the application program. In this way, as indicated in FIG. 1, the control unit 10 is configured to implement the functions of the virtual-space creation unit 101, the three-dimensional model disposition unit 102, the measurement-site setting unit 103, the distance calculation unit 104, the area calculation unit 105, the measurement-site evaluation unit 106, the teaching-point generation unit 107, the measurement-site measurement unit 108, the disposition-position error calculation unit 109, and the disposition-position correction unit 110. The RAM stores various types of data such as temporary computational data and display data. The CMOS memory is formed as a nonvolatile memory backed up by an unshown battery, and the storage status thereof is maintained even when the programming device 1 is turned off.

The virtual-space creation unit 101 creates a virtual space three-dimensionally representing a workspace in which the robot (not shown), the pin (not shown), the workpiece (not shown), and peripheral equipment such as a jig (not shown) are disposed.

For example, in accordance with an input operation performed by the user on the input unit 11, the three-dimensional model disposition unit 102 disposes a robot model of the robot (not shown), a pin model of the pin (not shown), a workpiece model of the workpiece (not shown), and a peripheral equipment model of, for example, a jig (not shown) in the three-dimensional virtual space created by the virtual-space creation unit 101.

Specifically, the three-dimensional model disposition unit 102 reads a robot model of the unshown robot from the model storage unit 131 in order to dispose the robot in the virtual space. The three-dimensional model disposition unit 102 disposes, in the virtual space, the robot model that has been read.

The three-dimensional model disposition unit 102 also reads a pin model of the unshown pin from the model storage unit 131 in order to dispose the pin model of the pin at the tool leading end of the robot in the virtual space. The three-dimensional model disposition unit 102 disposes, in the virtual space, the pin model of the pin that has been read, such that the pin model is attached to the tool leading end of the robot model.

The three-dimensional model disposition unit 102 also reads a workpiece model of the unshown workpiece from the model storage unit 131 in order to dispose the workpiece model of the workpiece in the virtual space. The three-dimensional model disposition unit 102 disposes, in the virtual space, the workpiece model of the workpiece that has been read.

The three-dimensional model disposition unit 102 also reads a peripheral equipment model of, for example, an unshown jig from the model storage unit 131 in order to dispose the peripheral equipment model in the virtual space. The three-dimensional model disposition unit 102 disposes, in the virtual space, the peripheral equipment model that has been read.

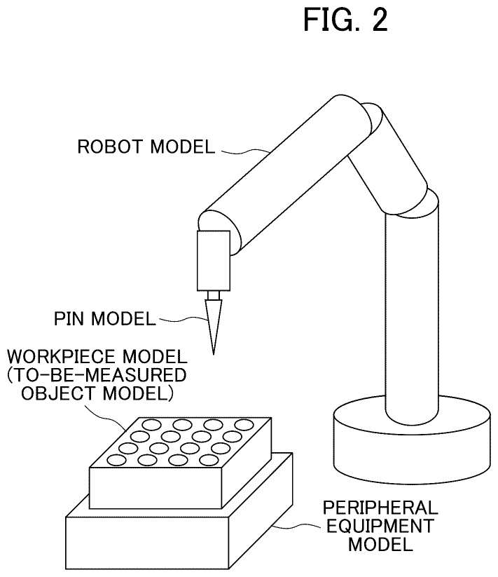

FIG. 2 illustrates an example of the industrial machine system model in the virtual space.

As depicted in FIG. 2, for example, a plurality of holes are provided in the upper surface of the workpiece model. However, the upper surface of the workpiece model is not limited to being provided with a plurality of holes, but may be provided with, for example, a plurality of projections.

The measurement-site setting unit 103 sets a plurality of measurement sites on the workpiece model, i.e., a to-be-measured object model.

Specifically, for example, on the basis of an input operation performed by the user on the input unit 11, the measurement-site setting unit 103 extracts a prescribed number of shape-related features in response to, for example, the centers of the holes in the workpiece model being clicked with a mouse or touched with a touch panel as shape-related features, and sets the extracted shape-related features as a plurality of measurement sites.

The following description is based on the assumption that the prescribed number is three, but the description is also applicable when the prescribed number is four or larger. The measurement-site setting unit 103 may also extract the surface centers of the projections on a workpiece model as shape-related features.

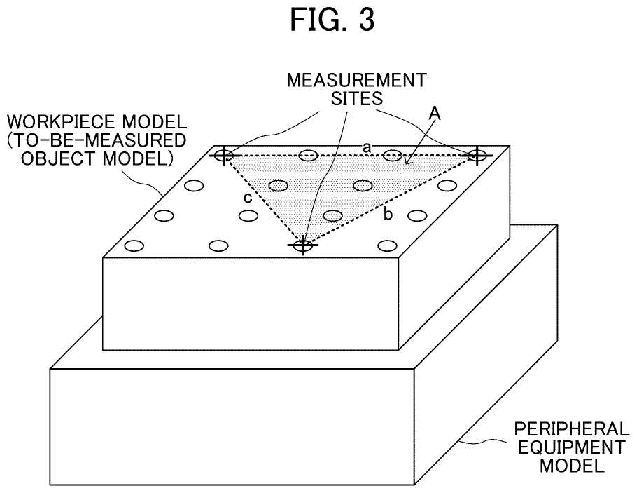

FIG. 3 illustrates an example of a situation in which a plurality of measurement sites have been set. In FIG. 3, three cross marks indicate the measurement sites that have been set.

The distance calculation unit 104 calculates the distances between adjacent measurement sites in a region formed by linking the prescribed number of measurement sites that have been set by the measurement-site setting unit 103.

Specifically, as indicated in FIG. 3, the distance calculation unit 104 calculates the distances (a, b, c, d) between adjacent measurement sites, and a length d (=a+b+c) of the perimeter of the triangle, i.e., total of the distances (a, b, c). Unless otherwise noted, the length d of the perimeter may hereinafter be referred to as the “distance d.”

The area calculation unit 105 calculates an area A of the triangular region surrounded by the measurement sites by using a publicly known technique for those skilled in the art. Note that, when the prescribed number is four or larger, the shape of the region is a polygon having four or more sides.

On the basis of the distances (a, b, c, d) calculated by the distance calculation unit 104 and the area A calculated by the area calculation unit 105, the measurement-site evaluation unit 106 evaluates whether measurement with a prescribed accuracy set in advance or greater can be performed at the measurement sites set by the measurement-site setting unit 103.

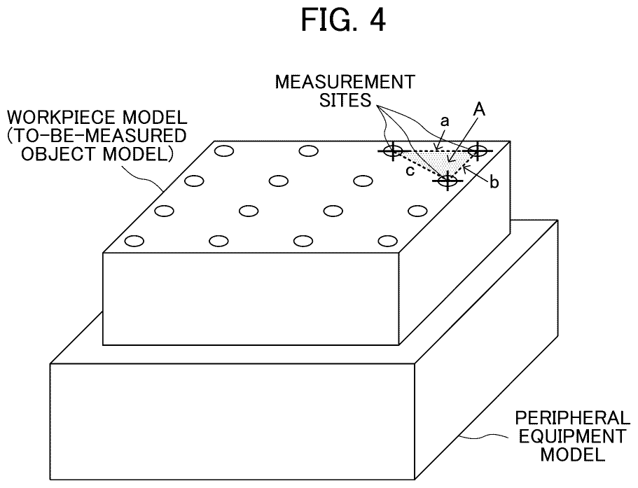

When, for example, three adjacent shape-related features have been set as a plurality of measurement sites in a manner such as that depicted in FIG. 4, the distances (a, b, c, d) and the area A are not equal to or greater than a distance threshold Th1 and an area threshold Th2 that indicate the prescribed accuracy, due to the plurality of measurement sites being excessively close to each other. Thus, the measurement-site evaluation unit 106 evaluates that measurement with the prescribed accuracy or greater cannot be performed at the measurement sites set in FIG. 4. In this case, since the error may become larger as the distance from the plurality of measurement sites that have been set increases, the measurement-site evaluation unit 106 may display a message of, for example, “Sufficient measurement accuracy may not be achieved because the distances between measurement sites are short and thus the measurement range is narrow” on the display unit 12, thereby causing the user to reset measurement sites. It should be noted that the distance threshold Th1 and the area threshold Th2 that indicate the prescribed accuracy are preferably set in advance, as appropriate, according to, for example, the shape and size of the workpiece.

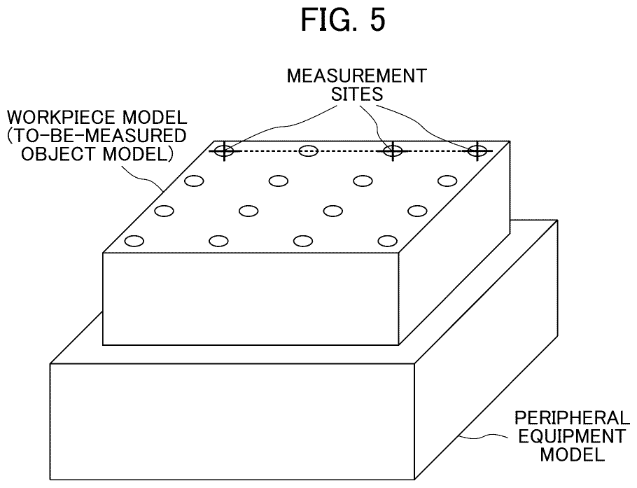

Meanwhile, when, as depicted in FIG. 5, three shape-related features arranged in the same straight line have been set as a plurality of measurement sites, the area A of the region is “0” and thus the area threshold Th2 indicating the prescribed accuracy is not reached or exceeded, so the measurement-site evaluation unit 106 evaluates that measurement with the prescribed accuracy or greater cannot be performed at the plurality of measurement sites set in FIG. 5. In this case, since the accuracy of the rotation of the workpiece (to-be-measured object) may not be appropriately achieved, the measurement-site evaluation unit 106 may display a message of, for example, “Sufficient measurement accuracy may not be achieved because the measurement sites are arranged in a straight line” on the display unit 12, thereby causing the user to reset measurement sites.

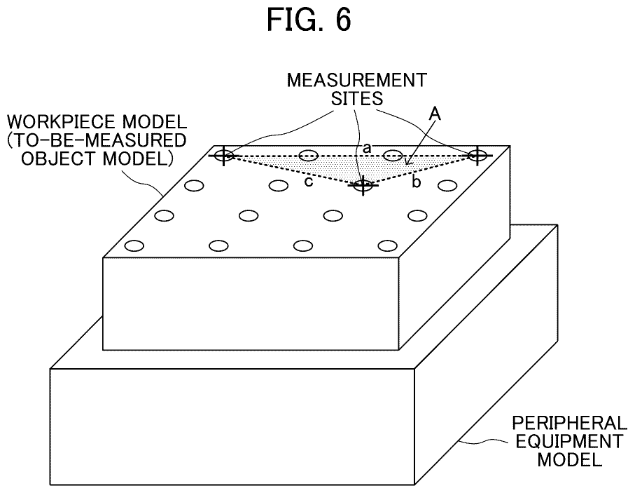

Meanwhile, when three shape-related features have been set as a plurality of measurement sites in a manner such as that depicted in FIG. 6, at least the area A of the region is less than the area threshold Th2, so the measurement-site evaluation unit 106 evaluates that measurement with the prescribed accuracy or greater cannot be performed at the plurality of measurement sites set in FIG. 6. In this case, the measurement-site evaluation unit 106 may display a message of, for example, “Although the distances between the measurement sites are sufficient, sufficient measurement accuracy may not be achieved because the measurement range is narrow” on the display unit 12, thereby causing the user to reset measurement sites.

Meanwhile, when three shape-related features have been set as a plurality of measurement sites in a manner such as that depicted in FIG. 3, the distances (a, b, c, d) and the area A are equal to or greater than the distance threshold Th1 and the area threshold Th2, so the measurement-site evaluation unit 106 evaluates that measurement with the prescribed accuracy or greater can be performed at the plurality of measurement sites set in FIG. 3. In this case, since the measurement accuracy is enhanced by covering a wide range on the workpiece (to-be-measured object), the measurement-site evaluation unit 106 may display a message of, for example, “Both the distances between the measurement sites and the measurement range are sufficient, so it is considered that sufficient measurement accuracy can be achieved” on the display unit 12.

When the measurement-site evaluation unit 106 has evaluated that measurement with the prescribed accuracy or greater can be performed, the teaching-point generation unit 107 generates the plurality of set measurement sites as teaching points to be measured by the robot (not shown), and sets the same for the measurement program.

For example, the measurement-site measurement unit 108 measures the positions of the plurality of measurement sites on the workpiece model by executing, in the virtual space, the measurement program for which the plurality of measurement sites have been set as teaching points, and measures the positions of the plurality of measurement sites on the workpiece by executing the same measurement program in the real space.

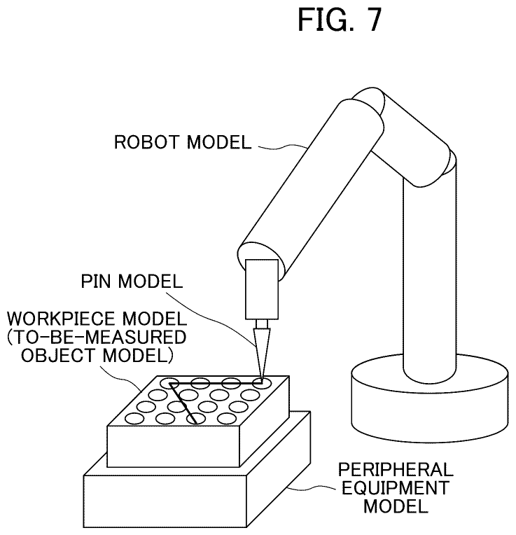

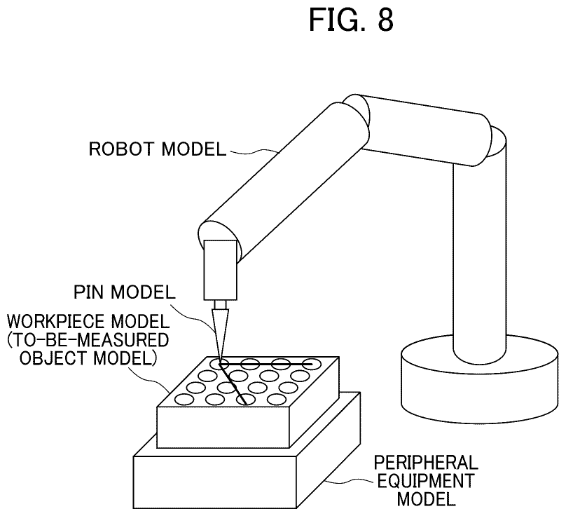

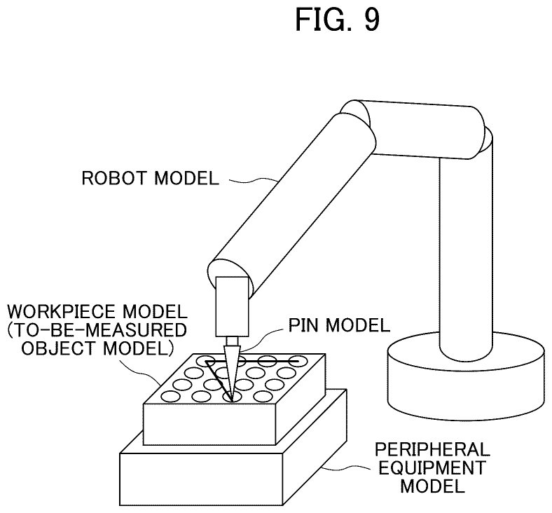

Specifically, for example, by executing the measurement program in the virtual space, the measurement-site measurement unit 108 operates the robot model as depicted in FIGS. 7 to 9, so as to touch up the three measurement sites (teaching points) on the workpiece model by using the pin model attached to the tool leading end of the robot model and measure the positions of the three measurement sites (teaching points). The measurement-site measurement unit 108 stores the measured positions of the three measurement sites (teaching points) in the storage unit 13.

Next, by executing the measurement program in the real space, the measurement-site measurement unit 108 operates the robot (not shown) as in the case of FIGS. 7 to 9, so as to touch up the three measurement sites (teaching points) on the workpiece (not shown) by using the pin (not shown) attached to the tool leading end of the robot (not shown) and measure the positions of the three measurement sites (teaching points). The measurement-site measurement unit 108 stores the measured positions of the three measurement sites (teaching points) in the storage unit 13.

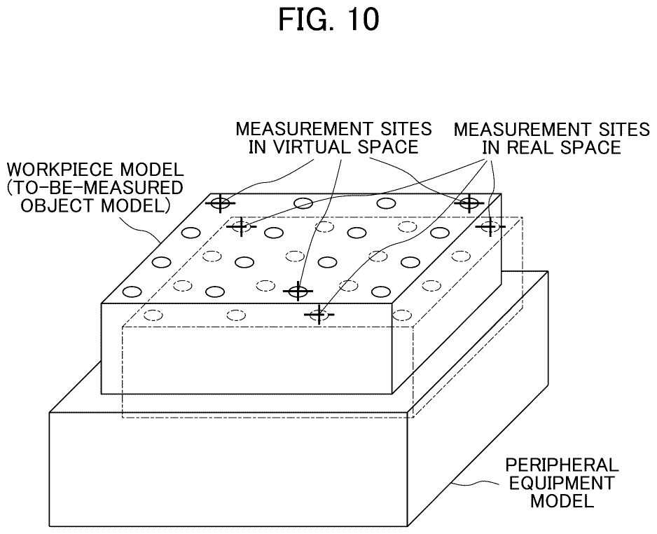

For example, as indicated in FIG. 10, the disposition-position error calculation unit 109 calculates an error in disposition position between the workpiece model in the virtual space and the workpiece (not shown) in the real space by using a publicly known technique for those skilled in the art on the basis of the positions of the three measurement sites on the workpiece model in the virtual space and the positions of the three measurement sites on the workpiece (not shown) in the real space.

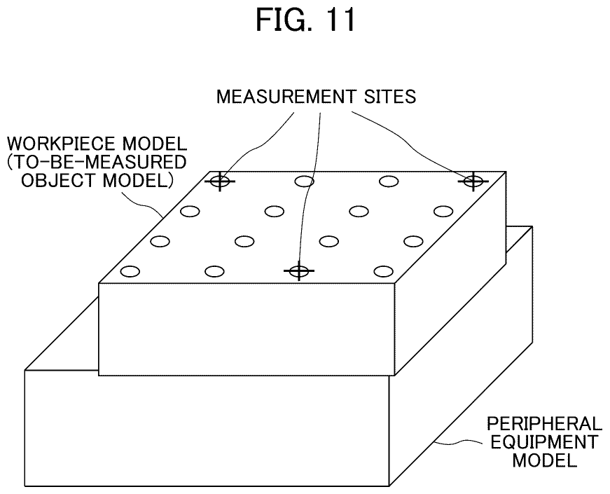

As indicated in FIG. 11, the disposition-position correction unit 110 corrects the disposition position of the workpiece model in the virtual space such that the error in disposition position calculated by the disposition-position error calculation unit 109 is eliminated.

### Correction Processing Performed by Programming Device 1

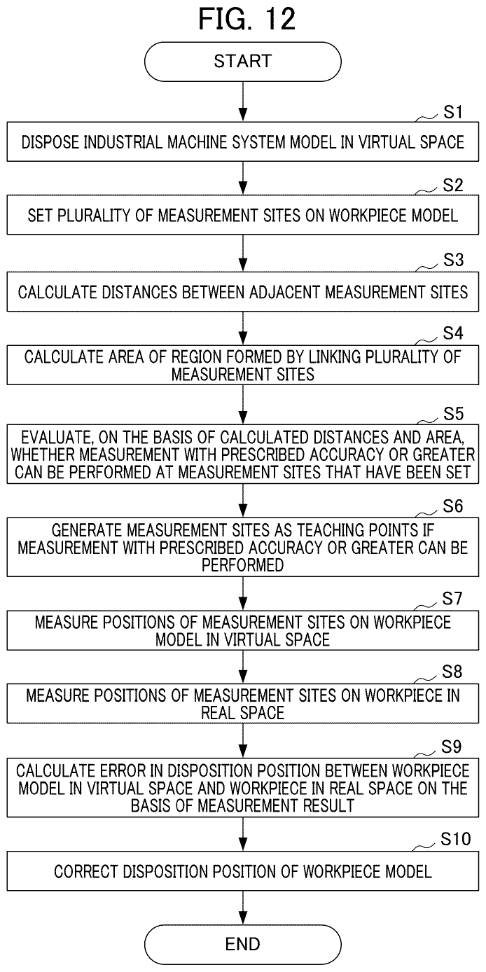

The following describes correction processing performed by the programming device 1 by referring to FIG. 12.

FIG. 12 is a flowchart illustrating correction processing performed by the programming device 1. The flow indicated herein is performed every time the measurement program is created.

In Step S1, in accordance with an input operation performed by the user on the input unit 11, the three-dimensional model disposition unit 102 disposes a robot model of a robot (not shown), a pin model of a pin (not shown), a workpiece model of a workpiece (not shown), and a peripheral equipment model of, for example, a jig (not shown) in a three-dimensional virtual space created by the virtual-space creation unit 101, the robot model, the pin model, and the workpiece model forming an industrial machine system model.

In Step S2, the measurement-site setting unit 103 sets a plurality of measurement sites on the workpiece model.

In Step S3, the distance calculation unit 104 calculates the distances (a, b, c, d) between adjacent measurement sites.

In Step S4, the area calculation unit 105 calculates the area A of a region formed by linking the plurality of measurement sites that have been set in Step S2.

In Step S5, on the basis of the distances (a, b, c, d) calculated in Step S3 and the area A calculated in Step S4, the measurement-site evaluation unit 106 evaluates whether measurement with a prescribed accuracy set in advance or greater can be performed at the plurality of measurement sites set in Step S2.

When it has been evaluated in Step S5 that measurement with the prescribed accuracy or greater can be performed, the teaching-point generation unit 107, in Step S6, generates the plurality of set measurement sites as teaching points to be measured by the robot (not shown), and sets the same for the measurement program. When it has been evaluated in Step S5 that measurement with the prescribed accuracy or greater cannot be performed, the programming device 1 returns to the process of Step S2.

In Step S7, the measurement-site measurement unit 108 measures the positions of the plurality of measurement sites on the workpiece model by executing, in the virtual space, the measurement program for which the plurality of measurement sites have been set as teaching points in Step S6.

In Step S8, the measurement-site measurement unit 108 measures the positions of the plurality of measurement sites on the workpiece (not shown) by executing, in the real space, the measurement program for which the measurement sites have been set as teaching points in Step S6.

In Step S9, the disposition-position error calculation unit 109 calculates an error in disposition position between the workpiece model in the virtual space and the workpiece (not shown) in the real space on the basis of the positions of the plurality of measurement sites that have been measured on the workpiece model in the virtual space and the positions of the measurement sites that have been measured on the workpiece (not shown) in the real space.

In Step S10, the disposition-position correction unit 110 corrects the disposition position of the workpiece model in the virtual space such that the error in disposition position calculated in Step S9 is eliminated.

Accordingly, the programming device 1 according to the first embodiment sets a plurality of measurement sites on the workpiece model in such a manner as to allow for the measurement of a wide range by making it so that; the distances (a, b, c, d) between adjacent measurement sites are equal to or greater than the threshold Th1; and the area A of a region formed by linking the measurement sites is equal to or greater than the threshold Th2. In this way, the programming device 1 can easily set teaching points for the measurement program for measuring a plurality of measurement sites on the workpiece (to-be-measured object).

The programming device 1 can accurately measure the positions of measurement sites in the virtual space and in the real space by setting, as teaching points for the measurement program, a plurality of measurement sites for which it has been evaluated that measurement can be performed with a prescribed accuracy or greater, thereby suppressing misalignment after correction between the position of the workpiece model (to-be-measured object model) in the virtual space and the position of the workpiece (to-be-measured object) in the real space.

Furthermore, the programming device 1 can set a plurality of appropriate measurement sites in a short time irrespective of the operator's experience.

In addition, the programming device 1 can reduce the risk of having to perform the processing again starting from the creation of the measurement program in the virtual space due to measurement sites being inappropriately set and thus misalignment after correction becoming larger between the position of the workpiece model (to-be-measured object model) in the virtual space and the position of the workpiece (to-be-measured object) in the real space.

So far, descriptions have been given of the first embodiment.

### Second Embodiment

The following describes the second embodiment. In the first embodiment, the programming device 1 involves: setting, on a to-be-measured object model, a plurality of measurement sites selected by a user; calculating the distances between adjacent measurement sites in a region formed by linking the plurality of measurement sites that have been set; calculating the area of the region; evaluating, on the basis of the area and the distances between the adjacent measurement sites, whether measurement with a prescribed accuracy set in advance or greater can be performed at the plurality of measurement sites; and generating, when it has been evaluated that measurement with the prescribed accuracy or greater can be performed, the plurality of measurement sites as teaching points to be measured by an industrial machine. The second embodiment differs from the first embodiment in terms of a programming device 1A involving: creating a plurality of combinations each constituted by a prescribed number of shape-related features from among shape-related features on a to-be-measured object model; calculating, for each of the plurality of combinations, the distances between adjacent shape-related features and the area of a region formed by linking the shape-related features; and evaluating, as a plurality of measurement sites at which measurement with a prescribed accuracy or greater can be performed, the combination of shape-related features that exhibits the highest value in terms of the calculated distances and area.

In this way, the programming device IA according to the second embodiment can easily set teaching points for the measurement program for measuring a plurality of measurement sites on the to-be-measured object.

In the following, descriptions are given of the second embodiment.

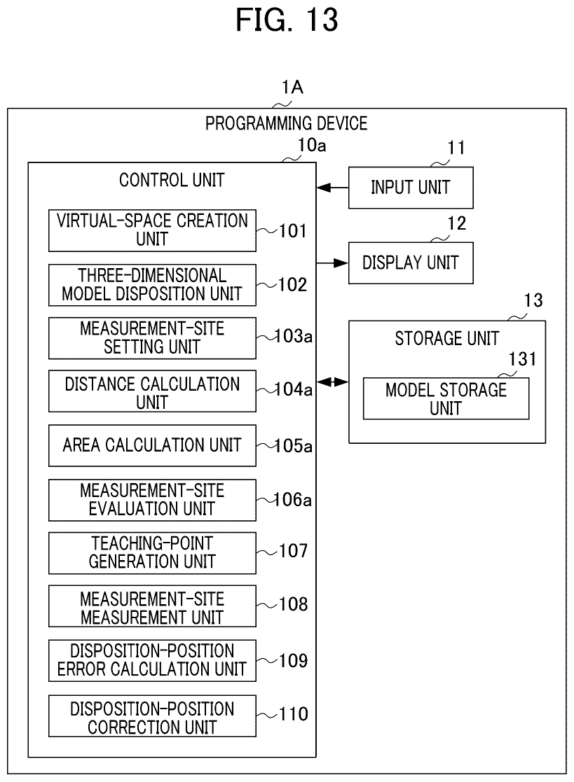

FIG. 13 is a functional block diagram illustrating a functional configuration example of the programming device according to the second embodiment. Like elements that have similar functions to the elements of the programming device 1 in FIG. 1 are denoted by like reference marks, and detailed descriptions thereof are omitted herein.

As depicted in FIG. 13, the programming device 1A according to the second embodiment includes a control unit 10a, an input unit 11, a display unit 12, and a storage unit 13. The control unit 10 includes a virtual-space creation unit 101, a three-dimensional model disposition unit 102, a measurement-site setting unit 103a, a distance calculation unit 104a, an area calculation unit 105a, a measurement-site evaluation unit 106a, a teaching-point generation unit 107, a measurement-site measurement unit 108, a disposition-position error calculation unit 109, and a disposition-position correction unit 110.

The input unit 11, the display unit 12, and the storage unit 13 have similar functions to the input unit 11, the display unit 12, and the storage unit 13 in the first embodiment.

The model storage unit 131 has similar functions to the model storage unit 131 in the first embodiment.

### Control Unit 10a

The control unit 10a includes, for example, a CPU, a ROM, a RAM, and a CMOS memory, which are publicly known to those skilled in the art and configured to be capable of communicating with each other via a bus.

The CPU is a processor that controls the entirety of the programming device 1A. The CPU reads, via the bus, a system program and an application program stored in the ROM, and controls the entirety of the programming device 1A in accordance with the system program and the application program. In this way, as indicated in FIG. 13, the control unit 10 is configured to implement the functions of the virtual-space creation unit 101, the three-dimensional model disposition unit 102, the measurement-site setting unit 103a, the distance calculation unit 1048, the area calculation unit 105a, the measurement-site evaluation unit 106a, the teaching-point generation unit 107, the measurement-site measurement unit 108, the disposition-position error calculation unit 109, and the disposition-position correction unit 110.

The virtual-space creation unit 101, the three-dimensional model disposition unit 102, the teaching-point generation unit 107, the measurement-site measurement unit 108, the disposition-position error calculation unit 109, and the disposition-position correction unit 110 have equivalent functions to the virtual-space creation unit 101, the three-dimensional model disposition unit 102, the teaching-point generation unit 107, the measurement-site measurement unit 108, the disposition-position error calculation unit 109, and the disposition-position correction unit 110 in the first embodiment.

The measurement-site setting unit 103a sets a plurality of measurement sites by extracting shape-related features on a workpiece model.

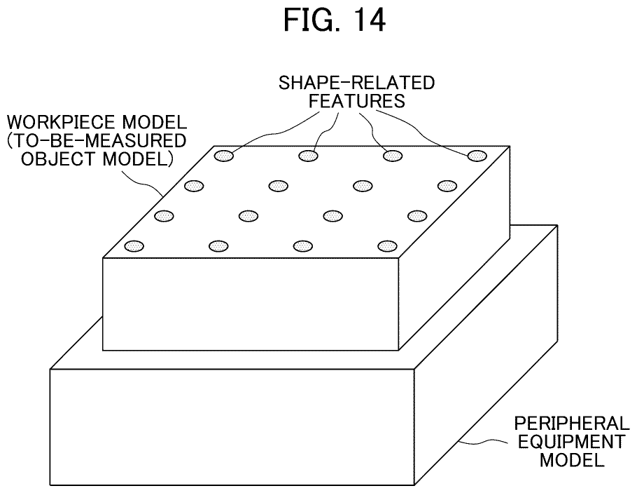

Specifically, for example, the measurement-site setting unit 103a automatically extracts the centers of holes in the workpiece model as shape-related features, as indicated in FIG. 14. The measurement-site setting unit 103a sets, as a plurality of measurement sites, a plurality of combinations each obtained by selecting a prescribed number of shape-related features from among the plurality of extracted shape-related features.

The following description is based on the assumption that the prescribed number is three, but the description is also applicable when the prescribed number is four or larger. When a plurality of projections are formed on a workpiece model, the measurement-site setting unit 103a may also extract the surface centers of the projections as shape-related features.

For each of the plurality of combinations that have been set, the distance calculation unit 104a calculates the distances (a, b, c, d) between adjacent shape-related features in a region formed by linking the shape-related features, as with the distance calculation unit 104 in the first embodiment.

For each of the plurality of combinations, the area calculation unit 105a calculates the area A of the region, as with the area calculation unit 105 in the first embodiment.

The measurement-site evaluation unit 106a evaluates, as a plurality of measurement sites at which measurement with a prescribed accuracy or greater can be performed, the combination of shape-related features that exhibits the highest value in terms of the distances (a, b, c, d) between adjacent shape-related features and the area A among the plurality of combinations.

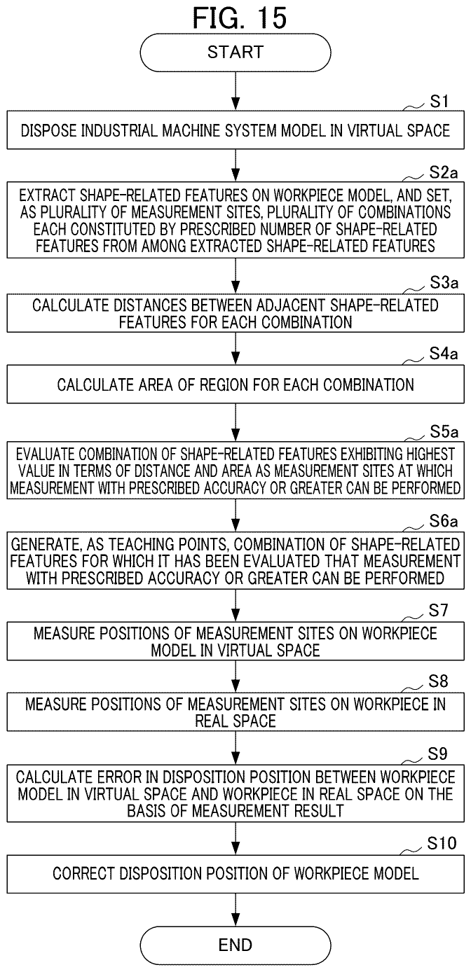

Correction processing performed by programming device 1A The following describes the flow of correction processing performed by the programming device 1A by referring to FIG. 15.

FIG. 15 is a flowchart illustrating correction processing performed by the programming device 1A. Processes similar to those in the correction processing in FIG. 12 performed by the programming device 1 are denoted by the same step numbers, and detailed descriptions thereof are omitted herein.

In Step S2a, the measurement-site setting unit 103a extracts shape-related features on a workpiece model, and sets, as a plurality of measurement sites, a plurality of combinations each obtained by selecting a prescribed number of shape-related features from among the plurality of extracted shape-related features.

In Step S3a, for each of the plurality of combinations that have been set, the distance calculation unit 104a calculates the distances (a, b, c, d) between adjacent shape-related features in a region formed by linking the shape-related features.

In Step S4a, for each of the plurality of combinations, the area calculation unit 105a calculates the area A of the region.

In Step S5a, the measurement-site evaluation unit 106a evaluates, as a plurality of measurement sites at which measurement with the prescribed accuracy or greater can be performed, the combination of shape-related features that exhibits the highest value in terms of the distances (a, b, C, d) calculated in Step S3a and the area A calculated in Step S4a.

In Step S6a, the teaching-point generation unit 107 generates, as teaching points to be measured by a robot (not shown), the combination of shape-related features evaluated in Step S5a, and sets the generated teaching points for the measurement program.

Accordingly, the programming device 1A according to the second embodiment involves: creating a plurality of combinations each constituted by a prescribed number of shape-related features from among shape-related features on a to-be-measured object model; calculating, for each of the plurality of combinations, the distances between adjacent shape-related features and the area of a region formed by linking the shape-related features; and evaluating, as a plurality of measurement sites at which measurement with a prescribed accuracy or greater can be performed, the combination of shape-related features that exhibits the highest value in terms of the calculated distances and area. In this way, the programming device 1A can easily set teaching points for the measurement program for measuring a plurality of measurement sites on the workpiece (to-be-measured object).

The programming device 1A can accurately measure the positions of measurement sites in the virtual space and in the real space by setting, as teaching points for the measurement program, measurement sites for which it has been evaluated that measurement can be performed with a prescribed accuracy or greater, thereby suppressing misalignment after correction between the position of the workpiece model (to-be-measured object model) in the virtual space and the position of the workpiece (to-be-measured object) in the real space.

Furthermore, the programming device LA can set appropriate measurement sites in a short time irrespective of the operator's experience.

In addition, the programming device 1A can reduce the risk of having to perform the processing again starting from the creation of the measurement program in the virtual space due to measurement sites being inappropriately set and thus misalignment after correction becoming larger between the position of the workpiece model (to-be-measured object model) in the virtual space and the position of the workpiece (to-be-measured object) in the real space.

So far, descriptions have been given of the second embodiment.

Although the first and second embodiments have been described, the programming devices 1 and 1A are not limited to the above-described embodiments and include, for example, variations and improvements as long as objectives can be attained.

### First Variation

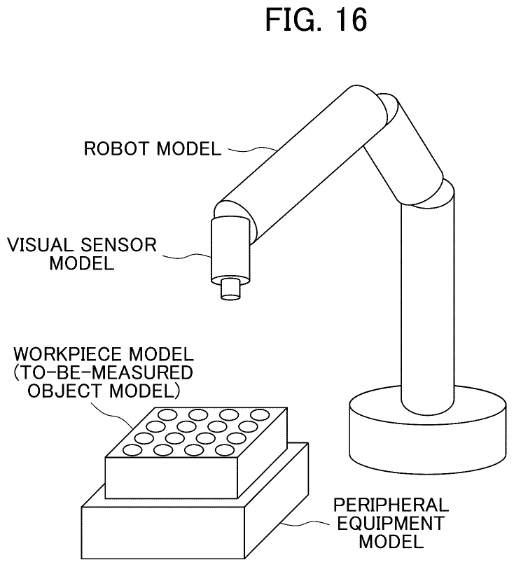

In the first and second embodiments, a pin for touch-up is attached to the tool leading end of the unshown robot model. However, the present invention is not limited to this. For example, as depicted in FIG. 16, the tool leading end of the unshown robot model may have, for example, a visual sensor for detection attached thereto. In this case, by executing the measurement program in a virtual space (or real space), the programming device 1, 1A may operate the robot model (or robot) as depicted in FIGS. 7 to 9, so as to detect each of a plurality of measurement sites by using a visual sensor model (or visual sensor) and measure the positions of the measurement sites.

### Second Variation

In the first and second embodiments, for example, the programming devices 1 and 1A measure the positions of a plurality of measurement sites on the upper surface of a workpiece model (or workpiece) by executing the measurement program in the virtual space (or real space). However, the present invention is not limited to this. For example, the programming devices 1 and 1A may measure the positions of a plurality of measurement sites on a side surface of the workpiece model (or workpiece) by executing the measurement program in the virtual space (or real space).

### Third Variation

In the second embodiment, for example, the programming device 1A extracts shape-related features on a workpiece model, and creates a plurality of combinations each obtained by selecting a prescribed number of shape-related features from among all of the extracted shape-related features. However, the present invention is not limited to this. For example, on the basis of an input operation performed by a user with the input unit 11, the programming device 1A may designate shape-related features to be excluded from among extracted shape-related features.

The functions included in the programming devices 1 and 1A in the first and second embodiments may each be implemented by hardware, software, or a combination thereof. In this regard, the wording “implemented by software” means being implemented by a computer reading a program.

The program may be stored in various types of non-transitory computer readable media and supplied to the computer. The non-transitory computer readable media include various types of tangible storage media. Examples of the non-transitory computer readable media include magnetic recording media (e.g., flexible disk, magnetic tape, hard disk drive), magneto-optical recording media (e. g., magneto-optical disk), read only memories (CD-ROMs), CD-Rs, CD-R/Ws, and semiconductor memories (e.g., Mask ROM, programmable ROM (PROM), erasable PROM (EPROM), flash ROM, RAM). The program may be supplied to a computer by various types of transitory computer readable media. Examples of the transitory computer readable media include electric signals, optical signals, and electromagnetic waves. The transitory computer readable media can supply programs to a computer through wireless communication paths or wire communication paths such as electric wires and optical fibers.

Steps for describing programs recorded in the recording medium include processes that are performed in order in time series, and processes that are not necessarily performed in time series but are performed in parallel or separately from each other.

Accordingly, the programming device of the present disclosure can implement various types and forms of embodiments having the following configuration.

(1) The programming device 1 of the present disclosure is one for creating a measurement program, the measurement program being for disposing, in a virtual space, an industrial machine system model that three-dimensionally represents an industrial machine system including a robot (not shown) and a workpiece (not shown) and includes a robot model and a workpiece model, and for measuring a plurality of measurement sites on the to-be-measured object model, the programming device including: a measurement-site setting unit 103 configured to set the plurality of measurement sites on the workpiece model; a distance calculation unit 104 configured to calculate the distances (a, b, c, d) between adjacent measurement sites in a region formed by linking the plurality of measurement sites; an area calculation unit 105 configured to calculate the area A of the region; a measurement-site evaluation unit 106 configured to evaluate, on the basis of the area A and the distances (a, b, c, d) between the adjacent measurement sites, whether measurement with a prescribed accuracy set in advance or greater can be performed at the plurality of measurement sites; and a teaching-point generation unit 107 configured to generate, when the measurement-site evaluation unit 106 has evaluated that measurement with the prescribed accuracy or greater can be performed, the plurality of measurement sites as teaching points to be measured by the robot.

The programming device 1 can easily set teaching points for the measurement program for measuring a plurality of measurement sites on the to-be-measured object.

(2) The programming device 1 according to section (1) may further include: a measurement-site measurement unit configured to measure the positions of the plurality of measurement sites on the to-be-measured object model by executing a measurement program in the virtual space, and measures the positions of the plurality of measurement sites on the to-be-measured object by executing the measurement program in the real space; a disposition-position error calculation unit configured to calculate an error in disposition position between the to-be-measured object model and the to-be-measured object on the basis of the measured positions of the plurality of measurement sites on the to-be-measured object model and the measured positions of the plurality of measurement sites on the to-be-measured object; and a disposition-position correction unit configured to correct the disposition position of the to-be-measured object model such that the error in disposition position is eliminated.

(3) The programming device 1A according to section (1) may be configured such that the measurement-site setting unit 103a sets a plurality of measurement sites by extracting a plurality of shape-related features on a workpiece model.

(4) The programming device 1A according to section (3) may be configured such that: the measurement-site setting unit 103a sets, as a plurality of measurement sites, a plurality of combinations each obtained by selecting a prescribed number of shape-related features from among the plurality of extracted shape-related features; for each of the plurality of combinations that have been set, the distance calculation unit 104a calculates the distances between adjacent shape-related features in a region formed by linking the shape-related features; for each of the plurality of combinations, the area calculation unit 105a calculates the area of the region; and the measurement-site evaluation unit 106a evaluates, as a plurality of measurement sites at which measurement with the prescribed accuracy or greater can be performed, the combination of shape-related features that exhibits the highest value in terms of the distances between the adjacent shape-related features and the area of the region among the plurality of combinations.

(5) The programming devices 1 and 1A according to any of sections (1) to (4) may be configured such that, when the industrial machine is a robot, the measurement program touches up a plurality of measurement sites by using a pin attached to the arm leading end of the robot, and then performs measurement.

(6) The programming devices 1 and 1A according to any of sections (1) to (4) may be configured such that, when the industrial machine is a robot, the measurement program detects a plurality of measurement sites by using a visual sensor attached to the arm leading end of the robot, and then performs measurement.

EXPLANATION OF REFERENCE NUMERALS
1, 1A: Programming device
10, 10a: Control unit
101: Virtual-space creation unit
102: Three-dimensional model disposition unit
103, 103a: Measurement-site setting unit
104, 104a: Distance calculation unit
105, 105a: Area calculation unit
106, 106a: Measurement-site evaluation unit
107: Teaching-point generation unit
108: Measurement-site measurement unit
109: Disposition-position error calculation unit
110: Disposition-position correction unit
11: Input unit
12: Display unit
13: Storage unit
131: Model storage unit

1. A programming device for creating a measurement program, the measurement program being for disposing, in a virtual space, an industrial machine system model that three-dimensionally represents an industrial machine system including an industrial machine and a to-be-measured object and includes an industrial equipment model and a to-be-measured object model, and for measuring a plurality of measurement sites on the to-be-measured object model, the programming device comprising:
a measurement-site setting unit configured to set the plurality of measurement sites on the to-be-measured object model;
a distance calculation unit configured to calculate distances between adjacent measurement sites in a region formed by linking the plurality of measurement sites;
an area calculation unit configured to calculate an area of the region;
a measurement-site evaluation unit configured to evaluate, on a basis of the area and the distances between the adjacent measurement sites, whether measurement with a prescribed accuracy set in advance or greater can be performed at the plurality of measurement sites; and
a teaching-point generation unit configured to generate, when the measurement-site evaluation unit has evaluated that measurement with the prescribed accuracy or greater can be performed, the plurality of measurement sites as teaching points to be measured by the industrial machine.

2. The programming device according to claim 1, further comprising:
a measurement-site measurement unit configured to measure positions of the plurality of measurement sites on the to-be-measured object model by executing the measurement program in the virtual space, and measures the positions of the plurality of measurement sites on the to-be-measured object by executing the measurement program in a real space;
a disposition-position error calculation unit configured to calculate an error in disposition position between the to-be-measured object model and the to-be-measured object on a basis of the measured positions of the plurality of measurement sites on the to-be-measured object model and the measured positions of the plurality of measurement sites on the to-be-measured object; and
a disposition-position correction unit configured to correct the disposition position of the to-be-measured object model such that the error in disposition position is eliminated.

3. The programming device according to claim 1, wherein
the measurement-site setting unit sets the plurality of measurement sites by extracting a plurality of shape-related features on the to-be-measured object model.

4. The programming device according to claim 3, wherein
the measurement-site setting unit sets, as the plurality of measurement sites, a plurality of combinations each obtained by selecting a prescribed number of shape-related features from among the plurality of extracted shape-related features,
for each of the plurality of combinations that have been set, the distance calculation unit calculates distances between adjacent shape-related features in a region formed by linking the shape-related features,
for each of the plurality of combinations, the area calculation unit calculates an area of the region, and
the measurement-site evaluation unit evaluates, as the plurality of measurement sites at which measurement with the prescribed accuracy or greater can be performed, the combination of shape-related features that exhibits a highest value in terms of the distances between the adjacent shape-related features and the area of the region among the plurality of combinations.

5. The programming device according to claim 1, wherein
in a case where the industrial machine is a robot, the measurement program touches up the plurality of measurement sites by using a pin attached to an arm leading end of the robot, and then performs measurement.

6. The programming device according to claim 1, wherein
in a case where the industrial machine is a robot, the measurement program detects the plurality of measurement sites by using a visual sensor attached to an arm leading end of the robot, and then performs measurement.
